(19) United States
(12) Patent Application Publication
(10) Pub. No.: US 2025/0208408 A1
(43) Pub. Date: Jun. 26, 2025

(54) OPTICAL DEVICE AND IMAGING UNIT PROVIDED WITH OPTICAL DEVICE

(71) Applicant: Murata Manufacturing Co., Ltd., Nagaokakyo-shi (JP)

(72) Inventors: Noritaka KISHI, Nagaokakyo-shi (JP); Hitoshi SAKAGUCHI, Nagaokakyo-shi (JP)

(21) Appl. No.: 19/074,741

(22) Filed: Mar. 10, 2025

Related U.S. Application Data
(63) Continuation of application No. PCT/JP2023/023278, filed on Jun. 23, 2023.

(30) Foreign Application Priority Data
Oct. 19, 2022 (JP) 2022-167672

(51) Int. Cl. G02B 27/00

(52) U.S. Cl. CPC G02B 27/0006

(57) ABSTRACT

An optical device is provided for removing foreign matter adhering to a surface of a light transmitting body. The optical device includes an outermost layer lens, a housing, a vibration body, a piezoelectric element, and a drive circuit. The drive circuit causes a voltage of a driving signal that drives the piezoelectric element in an atomization mode to vibrate the outermost layer lens to be the same as a voltage of a driving signal that drives the piezoelectric element in a heating mode. The drive circuit drives the piezoelectric element such that an effective voltage applied to the piezoelectric element within a predetermined time period in the atomization mode is different from an effective voltage applied to the piezoelectric element within the predetermined time period in the heating mode.

### CROSS REFERENCE TO RELATED APPLICATIONS

This application is a continuation of International Application No. PCT/JP2023/023278, filed Jun. 23, 2023, which claims priority to Japanese Patent Application No. 2022-167672, filed Oct. 19, 2022, the contents of each of which are hereby incorporated by reference in their entirety.

### TECHNICAL FIELD

The present disclosure relates to an optical device and an imaging unit provided with an optical device.

### BACKGROUND

Safety equipment has been controlled and driving assistance control have been performed by providing an imaging unit to a front part and/or a rear part of a vehicle and utilizing an image acquired by the imaging unit. In many cases, such an imaging unit is provided outside of a vehicle, and thus foreign matter, such as raindrops (e.g., water droplets), mud, dust, and the like, may adhere to a light transmitting body, such as a protection cover or a lens, which is covering the exterior of the imaging unit. Moreover, in cold weather, the imaging unit provided outside of the vehicle may have ice or frost adhere to a surface of the light transmitting body, making it difficult to obtain clear images.

In this respect, in a lens cleaning system described in U.S. Patent Application Publication No. 2020/0282435, a light transmitting body is vibrated through a plurality of drive sequences including a dehydration sequence and a heating sequence, thus removing foreign matter adhering to a surface of the light transmitting body. This lens cleaning system varies voltage applied to a transducer, a time period and a frequency of vibration of the light transmitting body, and the like, in accordance with a type of the drive sequence.

However, in the system described therein, a drive circuit is required to be provided with a booster circuit for changing voltage to be applied to the transducer, which increases manufacturing costs of the drive circuit. Moreover, in this system, driving is performed with maximum power during vibration of the light transmitting body. Therefore, a circuit and wiring that withstand the maximum power are required, and thus system complexity may be caused.

### SUMMARY OF THE INVENTION

Thus, according to an exemplary aspect, the present disclosure provides an optical device configured to remove foreign matter adhering to a surface of a light transmitting body without configuration complexity, and an imaging unit provided with an optical device.

In an exemplary aspect, an optical device is provided that includes a light transmitting body configured to transmit light; a housing configured to hold the light transmitting body; a vibration body configured to contact the light transmitting body held by the housing; a piezoelectric element configured to vibrate the vibration body; and a drive circuit configured to drive the piezoelectric element. The vibration body is a cylindrical body and includes a first end and a second end at an opposite side from the first end. The first end contacts the light transmitting body and the piezoelectric element is on the second end. The drive circuit configures a voltage Vp-p_1 of an alternating current signal that drives the piezoelectric element in a first vibration mode to vibrate the light transmitting body to be the same as a voltage Vp-p_2 of an alternating current signal that drives the piezoelectric element in a second vibration mode, and drives the piezoelectric element such that an effective voltage Veff_1 applied to the piezoelectric element within a predetermined time period in the first vibration mode is different from an effective voltage Veff_2 applied to the piezoelectric element within the predetermined time period in the second vibration mode.

Moreover, according to an exemplary aspect, an imaging unit is provided that includes the above-described optical device; and an imaging element disposed such that the light transmitting body is disposed in a viewing direction thereof.

According to the exemplary aspects of the present disclosure, the piezoelectric element is driven such that voltage of an alternating current signal that drives the piezoelectric element is the same in the first vibration mode and the second vibration mode and the effective voltage Veff_1 in the first vibration mode is different from the effective voltage Veff_2 in the second vibration mode. Therefore, foreign matter adhering to the surface of the light transmitting body can be removed by the light transmitting body being vibrated at different frequencies without configuration complexity.

### BRIEF DESCRIPTION OF DRAWINGS

FIG. 1 is a half sectional view of an imaging unit according to Exemplary Embodiment 1.

FIG. 2 is a block diagram for explaining a configuration of a drive circuit according to Exemplary Embodiment 1.

FIG. 3 is a graph showing relationship between a frequency and an impedance when an optical device according to Exemplary Embodiment 1 is vibrated.

FIG. 4 is a chart for explaining a driving signal that drives a piezoelectric element by the drive circuit according to Exemplary Embodiment 1.

FIG. 5 is a graph for explaining relationship between a displacement of a light transmitting body and a duty ratio of a driving signal.

FIG. 6 is a graph for explaining change in a maximum displacement of a light transmitting body in accordance with change in a duty ratio of a driving signal.

FIG. 7 is a graph for explaining transient response of vibration when a light transmitting body is excited using a driving signal.

FIG. 8 is a circuit diagram for explaining a configuration of a drive circuit according to Exemplary Embodiment 2.

FIG. 9 is a chart for explaining a driving signal that drives a piezoelectric element by a drive circuit according to Exemplary Embodiment 3.

FIG. 10 is a circuit diagram for explaining a configuration of a drive circuit according to Embodiment 4.

FIG. 11 is a graph for explaining characteristics of a filter circuit included in the drive circuit according to Exemplary Embodiment 4.

### DETAILED DESCRIPTION OF EMBODIMENTS

Hereinafter, an optical device and an imaging unit provided with the optical device according to exemplary embodiments will be described in detail with reference to the drawings. It is noted that in the drawings, the same reference characters denote the same or corresponding portions. The optical device described below is applied to, for example, an in-vehicle imaging unit, and is configured to vibrate a light transmitting body (for example, an outermost layer lens) in order to remove foreign matter adhering to the surface of the light transmitting body. It is also noted that the optical device is not limitedly applied to an in-vehicle imaging unit. For example, the optical device can also be applied to a security monitoring camera, an imaging unit for a drone, and the like.

### Exemplary Embodiment 1

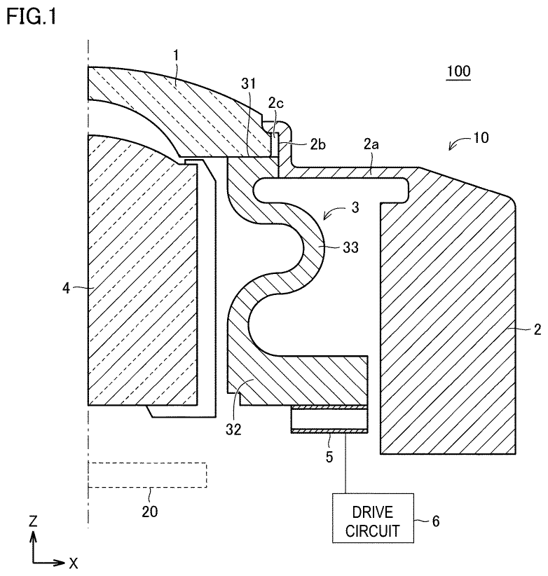

FIG. 1 is a half sectional view of an imaging unit 100 according to Exemplary Embodiment 1. It is noted that for purposes of this disclosure, an X-direction and a Z-direction in the drawings indicate a lateral direction and a height direction of the imaging unit 100, respectively. A one-dot chain line in FIG. 1 indicates a portion of the imaging unit 100 passing through a center axis thereof. The imaging unit 100 includes an optical device 10 and an imaging element 20 that is disposed such that an outermost layer lens 1 and an inner layer lens 4 are arranged in a viewing direction thereof. The imaging element 20 is, for example, an image sensor, such as a charge coupled device (CCD) and a complementary metal-oxide-semiconductor (CMOS) sensor and is mounted on a circuit board that is not illustrated.

The optical device 10 includes the outermost layer lens 1, a housing 2, a vibration body 3, the inner layer lens 4, a piezoelectric element 5, and a drive circuit 6. Note that, in the present disclosure, the optical device 10 includes at least the outermost layer lens 1, the housing 2, the vibration body 3, the piezoelectric element 5, and the drive circuit 6, and the inner layer lens 4 may be included in the imaging unit 100. In the optical device 10, the outermost layer lens 1 and the inner layer lens 4 are adjusted to be aligned, and then a case including the imaging element 20 is attached to the optical device 10, thus the imaging unit 100 being formed.

The outermost layer lens 1 is a light transmitting body that is configured to transmit light having a predetermined wavelength (for example, a wavelength of visible light, a wavelength that can be captured by an imaging element, or the like), and is, for example, a convex meniscus lens. The optical device 10 may employ a transparent member, such as a protection cover instead of the outermost layer lens 1 in an exemplary aspect. The protection cover can be made of glass or resin such as transparent plastics.

An end portion of the outermost layer lens 1 is held by an end portion of a plate spring 2a extending from the housing 2. It is noted that a space between the outermost layer lens 1 and a retainer 2b that is an end portion of the plate spring 2a is filled with an adhesive 2c. Moreover, although the end portion of the plate spring 2a holds the outermost layer lens 1, the housing 2 may directly or indirectly hold the outermost layer lens 1. Furthermore, in order to vibrate the outermost layer lens 1 held by the housing 2, the optical device 10 is provided with the vibration body 3 at a position in contact with the outermost layer lens 1.

The vibration body 3 is a cylindrical body, and one end portion 31 (e.g., a first end) thereof is in contact with the outermost layer lens 1, and the other end portion 32 (e.g., a second end) thereof, which is at an opposite side from the one end portion, is provided with the piezoelectric element 5. The vibration body 3 has a configuration in which the one end portion 31 and the other end portion 32 are connected to one another by a supporting part 33. Note that a cross-sectional shape of the supporting part 33 is an S-shape. As illustrated in FIG. 1, the inner layer lens 4 is disposed inside the cylinder of the vibration body 3.

The one end portion 31 has a shape extending in a radial direction (X and Y directions) of the cylindrical body and can stably be connected to a peripheral edge portion of the outermost layer lens 1. The other end portion 32 is a portion that vibrates as the piezoelectric element 5 vibrates and has a thickness larger than that of other portions. Therefore, vibration of the piezoelectric element 5 can more efficiently be transmitted to the outermost layer lens 1. The supporting part 33 is a portion that supports the one end portion 31 and transmits vibration of the other end portion 32 to the one end portion 31. Note that the one end portion 31, the other end portion 32, and the supporting part 33 may be formed integrally or be formed separately. Moreover, as illustrated in FIG. 1, a maximum external dimension of the supporting part 33 is larger than a maximum external dimension of the one end portion 31, and a maximum external dimension of the other end portion 32 is larger than the maximum external dimension of the supporting part 33. Therefore, vibration of the other end portion 32 (that is, vibration of the piezoelectric element 5) can efficiently be transmitted to the outermost layer lens 1 (i.e., the light transmitting body).

As further shown, the piezoelectric element 5 is provided on the other end portion 32. The piezoelectric element 5 has a hollow circular shape and, for example, vibrates by polarization in a thickness direction. The piezoelectric element 5 is made of PZT-based piezoelectric ceramics. However, other piezoelectric ceramics, such as (K, Na)NbO₃, may be used. Also, a piezoelectric single crystal, such as LiTaO₃, may be used. The piezoelectric element 5 is connected to the drive circuit 6 and vibrates the outermost layer lens 1 based on a signal from the circuit.

The drive circuit 6 can be configured to drive the piezoelectric element 5 in an atomization mode. In the atomization mode, the drive circuit 6 vibrates the outermost layer lens 1 at a resonant frequency of the vibration body 3 to remove foreign matter, such as a raindrop, mud, and dust, adhering to the outermost layer lens 1. Moreover, the drive circuit 6 can drive the piezoelectric element 5 in a heating mode. In the heating mode, the drive circuit 6 vibrates the outermost layer lens 1 at a natural vibration frequency of the outermost layer lens 1 to remove foreign matter, such as ice and frost, adhering to the outermost layer lens 1. The drive circuit 6 can drive the piezoelectric element 5 while switching between a plurality of vibration modes including the atomization mode and the heating mode. The drive circuit 6 also serves as a switch part (e.g., a switch) that is configured to switch the mode for vibrating the outermost layer lens 1 among the plurality of vibration modes.

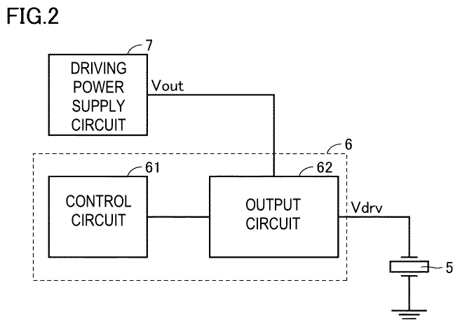

The drive circuit 6 is described in detail with reference to the drawings. FIG. 2 is a block diagram for explaining a configuration of the drive circuit 6 according to Exemplary Embodiment 1. FIG. 2 illustrates an example in which the piezoelectric element 5 is connected to the drive circuit 6 in a single-ended manner. However, this connection method is merely one example and is not so limited. A reference potential of the piezoelectric element 5 may be, for example, ground, or may be body earth connected to a negative pole of a battery.

The drive circuit 6 includes a control circuit 61 and an output circuit 62. The control circuit 61 controls the output circuit 62 to convert a voltage Vout supplied from a driving power supply circuit 7 into a drive voltage Vdrv to be output to the piezoelectric element 5. The drive circuit 6 adjusts the drive voltage Vdrv to be output to the piezoelectric element 5 to drive the piezoelectric element 5 while switching between the plurality of vibration modes including the atomization mode and the heating mode. Although the drive circuit 6 is described not to include the driving power supply circuit 7, the drive circuit 6 may include the driving power supply circuit 7.

The control circuit 61 controls a switching frequency of a plurality of switches included in the output circuit 62, thus adjusting a frequency of a driving signal. The control circuit 61 includes a general-purpose processor, such as a CPU or an MPU, that executes a program to implement a predetermined function. The control circuit 61 is configured to communicate with a storage device and can invoke and execute a computation program or the like stored in the storage device to implement various types of processing, such as switching processing of the plurality of switches, in the control circuit 61 and the like. It is noted that the control circuit 61 is not limited to have an aspect in which hardware resources and software work together to implement a predetermined function but may be a hardware circuit designed only for implementation of a predetermined function. That is, the control circuit 61 may be realized by various processors other than a CPU or an MPU, such as a GPU, an FPGA, a DSP, and an ASIC. Such a control circuit 61 may include, for example, a signal processing circuit that is a semiconductor integrated circuit.

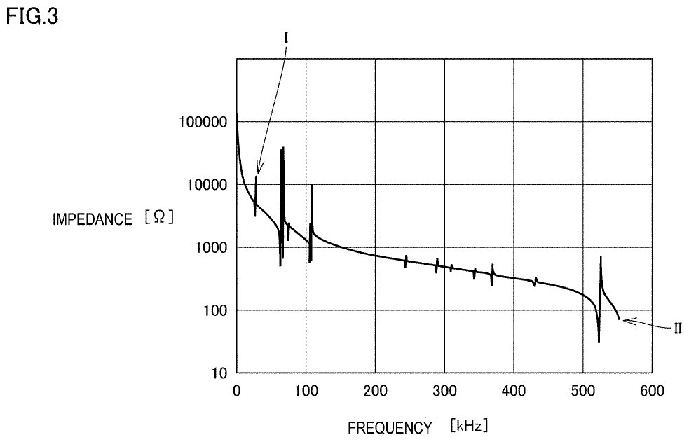

When a driving signal is applied to the piezoelectric element 5, an impedance of the piezoelectric element 5 changes in accordance with a frequency of the driving signal. FIG. 3 is a graph showing relationship between a frequency and an impedance when the optical device 10 according to Exemplary Embodiment 1 is vibrated. As illustrated in FIG. 3, the piezoelectric element 5 has a plurality of frequencies at which an impedance decreases locally. These frequencies correspond to resonant frequencies of the vibration body 3. The optical device 10 according to this embodiment has resonant frequencies at, for example, about 30 kHz (i.e., arrow I) and about 550 kHz (i.e., arrow II).

When the piezoelectric element 5 receives input of a driving signal corresponding to any of these resonant frequencies, the piezoelectric element 5 vibrates the outermost layer lens 1 in a vibration mode that varies depending on a frequency. For example, in a case in which a driving signal at a frequency of about 30 kHz is input, the piezoelectric element 5 vibrates the outermost layer lens 1 with the vibration body 3 interposed therebetween in a first vibration mode. The first vibration mode is a vibration mode for vibrating the outermost layer lens 1 as a whole. The first vibration mode is the atomization mode that is configured for atomizing and thus removing foreign matter, such as a droplet, adhering to the outermost layer lens 1.

Moreover, in a case in which a driving signal at a frequency of about 550 kHz is input, the piezoelectric element 5 vibrates the outermost layer lens 1 with the vibration body 3 interposed therebetween in a second vibration mode (e.g., a heating mode) in which the outermost layer lens 1 is easily increased in temperature. Vibration at a vicinity of about 550 kHz causes the outermost layer lens 1 to vibrate in a higher-order vibration mode having a larger number of nodes than that of vibration at about 30 kHz. In the heating mode, the piezoelectric element 5 has a small impedance, and thus a large amount of power is supplied to the piezoelectric element 5, which allows the outermost layer lens 1 to rapidly be increased in temperature.

Note that, at a frequency of about 110 kHz between the first vibration mode and the second vibration mode, a frequency that resonates with the natural vibration of the outermost layer lens 1 exists. When a driving signal at this frequency is input, the piezoelectric element 5 vibrates a center portion of the outermost layer lens 1 more largely than a peripheral edge portion of the outermost layer lens 1, with the vibration body 3 interposed therebetween. The piezoelectric element 5 may cause vibration other than the above-described vibration modes to the outermost layer lens 1. Moreover, the above-described resonant frequencies are merely one example and may be changed in accordance with a shape, a material, and the like of the optical device 10.

As illustrated in FIG. 3, when a driving signal at the frequency corresponding to the resonant frequency is input to the piezoelectric element 5, an impedance of the piezoelectric element 5 locally becomes minimum.

Conventionally, in a case in which the drive circuit 6 drives the piezoelectric element 5 while switching between a plurality of vibration modes as described above, the drive circuit 6 adjusts voltage to be applied to the piezoelectric element 5 in accordance with the switched vibration mode. However, in order for the drive circuit 6 to adjust voltage to be applied to the piezoelectric element 5, the drive circuit 6 is required to be provided with a booster circuit, which increases manufacturing costs of the drive circuit 6. Moreover, the atomization mode and the heating mode have different conditions from one another with regard to vibration acceleration required for vibration to be excited, and the like. For example, in the atomization mode, it is preferable that a frequency of vibration to be excited is several tens of kilohertz and vibration acceleration is more than 8.0×10⁵ m/s². On the other hand, in the heating mode, a frequency of vibration to be excited is several hundreds of kilohertz, and power that is sufficient for thaw as well as prevents overheating needs to be supplied to the piezoelectric element 5.

Moreover, the atomization mode and the heating mode have optimal vibration quantities different from one another, and voltages to be applied to the piezoelectric element 5 to realize these optimal vibration quantities are thus different. Generally, resonant resistance in the heating mode is significantly less than resonant resistance in the atomization mode. In a case in which the same voltage is applied to the piezoelectric element 5 in the heating mode, damage due to overheating and/or an increase in power consumption may be caused. Therefore, in a drive circuit that supplies a square wave by using a half-bridge circuit or the like, a booster circuit is required to adjust voltage to be applied to the piezoelectric element 5, which increases manufacturing costs of the drive circuit.

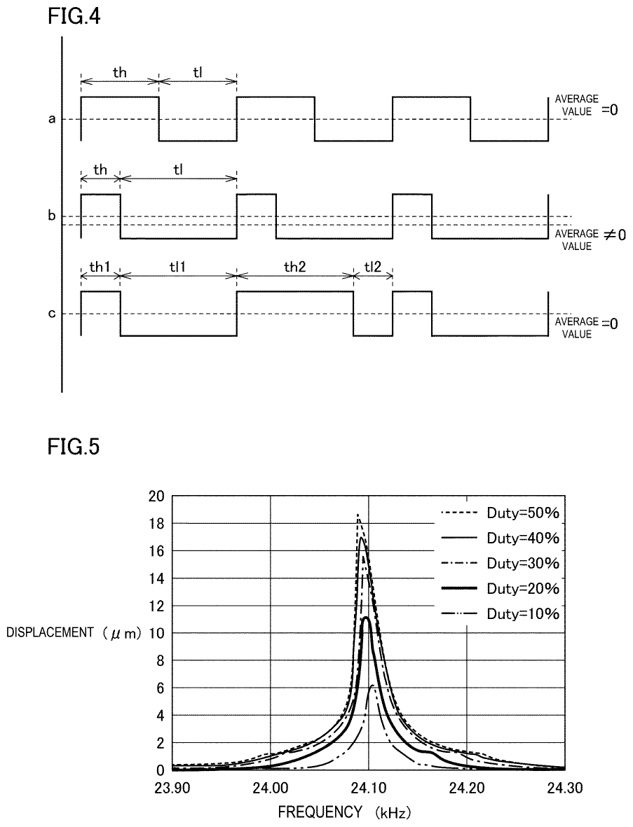

In this respect, in the optical device 10 according to this embodiment, the vibration mode can be switched by adjusting of a waveform itself of a driving signal to be input without changing of voltage to be applied from the drive circuit 6 to the piezoelectric element 5. FIG. 4 is a chart for explaining a driving signal that drives the piezoelectric element 5 by the drive circuit 6 according to Exemplary Embodiment 1. As indicated by a waveform a in FIG. 4, the drive circuit 6 outputs to the piezoelectric element 5, as a driving signal, a square wave in which a high time period th with voltage at a positive value and a low time period tl with voltage at a negative value form one period.

The drive circuit 6 can be configured to adjust, in accordance with the vibration mode, a length of the high time period th and a length of the low time period tl without changing a voltage value of the high time period th and a voltage value of the low time period tl. That is, the drive circuit 6 causes a voltage Vp-p_1 of a driving signal (alternating current signal) that drives the piezoelectric element 5 in the atomization mode to vibrate the outermost layer lens 1 to be the same as a voltage Vp-p_2 of a driving signal that drives the piezoelectric element 5 in the heating mode (Vp-p_1=Vp-p_2). Note that assuming that the drive circuit 6 includes the driving power supply circuit and the output circuit that converts direct-current voltage output from the driving power supply circuit into an alternating current signal, the direct-current voltage output from the driving power supply circuit may be defined to be the same in the plurality of vibration modes. That is, the drive circuit 6 causes a direct-current voltage Vout_1 for generating a driving signal (alternating current signal) that drives the piezoelectric element 5 in the atomization mode to vibrate the outermost layer lens 1 to be the same as a direct-current voltage Vout_2 for generating a driving signal that drives the piezoelectric element 5 in the heating mode (Vout 1=Vout_2).

Furthermore, the drive circuit 6 drives the piezoelectric element 5 such that an effective voltage Veff_1 applied to the piezoelectric element 5 within a predetermined time period in the atomization mode is different from an effective voltage Veff_2 applied to the piezoelectric element 5 within the predetermined time period in the heating mode (i.e., Veff_1≠Veff_2).

Here, a voltage Vp-p is voltage of difference (e.g., a peak-to-peak value) between a maximum value (+Vpp) and a minimum value (−Vpp) of a driving signal (alternating current signal). Moreover, an effective voltage Veff indicates a voltage value supplied as vibration of the outermost layer lens 1 when the piezoelectric element 5 is driven by the driving signal at the voltage Vp-p. The drive circuit 6 adjusts the length of the high time period th and the length of the low time period tl to change the effective voltage Veff, thus switching between the atomization mode and the heating mode. From a perspective of preventing overheating of the outermost layer lens 1 in the heating mode, the effective voltage Veff_1 applied to the piezoelectric element 5 within the predetermined time period in the atomization mode is preferably higher than the effective voltage Veff_2 applied to the piezoelectric element 5 within the predetermined time period in the heating mode (i.e., Veff_1>Veff_2).

Moreover, assume that a magnitude of displacement upon vibration of the outermost layer lens 1 is a vibration amplitude Av, and power input for excitation of the outermost layer lens 1 is power Pv. In the case in which the drive circuit 6 drives the piezoelectric element 5 in the atomization mode, in order to enable atomization and thus removal of foreign matter, such as a droplet, adhering to the outermost layer lens 1, the vibration amplitude Av of the outermost layer lens 1 is required to be larger than that in the case in which the piezoelectric element 5 is driven in the heating mode. That is, the drive circuit 6 preferably has a larger vibration amplitude Av_1 of the outermost layer lens 1 in the atomization mode than a vibration amplitude Av_2 of the outermost layer lens 1 in the heating mode (i.e., Av_1>Av_2).

Furthermore, as illustrated in FIG. 3, in the case in which the piezoelectric element 5 is driven in the heating mode, the resonant resistance is less than that in the case in which the piezoelectric element 5 is driven in the atomization mode, which increases the input power Pv. That is, the drive circuit 6 preferably has smaller input power Pv_1 in the atomization mode than input power Pv_2 in the heating mode (i.e., Pv_1<Pv_2). Therefore, the drive circuit 6 can efficiently drive the piezoelectric element 5 in each vibration mode of the atomization mode and the heating mode.

Assuming that a shorter time period min(th, tl) of the high time period th and the low time period tl is an active time period ta, a duty ratio of a driving signal can be represented by min(th, tl)/(th+tl)=ta/(th+tl). Adjusting the length of the high time period th and the length of the low time period tl also means adjusting a duty ratio of a driving signal. Therefore, the drive circuit 6 can be configured to change the effective voltage Veff by adjusting a duty ratio of a driving signal and can switch between the atomization mode and the heating mode without changing the voltage Vp-p to be applied to the piezoelectric element 5.

Generalized relationship between a driving signal in the atomization mode and a driving signal in the heating mode by using a duty ratio of a driving signal is relationship as represented by Formula 1.

$$\begin{matrix}[ Math . 1 ] & \\ \int \{ ta\_ 1 / ( th\_ 1 + tl\_ 1 ) \} dt > \int \{ ta\_ 2 / ( th\_ 2 + tl\_ 2 ) \} dt & ( Formula 1 )\end{matrix}$$

Here, assume that the atomization mode includes a high time period th_1, a low time period tl_1, and an active time period ta_1, and the heating mode includes a high time period th_2, a low time period tl_2, and an active time period ta_2. That is, in a case in which the drive circuit 6 drives the piezoelectric element 5 for a predetermined time period dt, the drive circuit 6 preferably has a first integral value larger than a second integral value. The first integral value is an integral of a duty ratio of a driving signal that drives the piezoelectric element 5 in the atomization mode over the predetermined time period dt. The second integral value is an integral of a duty ratio of a driving signal that drives the piezoelectric element 5 in the heating mode over the predetermined time period dt. In this manner, the drive circuit 6 can provide any adjustment of the effective voltage Veff by changing a duty ratio of a driving signal.

Returning to FIG. 4, in response to changing of a duty ratio of a driving signal, when the low time period tl increases as shown by a waveform b in FIG. 4, an average value of voltage over a plurality of periods does not become 0 (zero) V but takes a negative value. When the average value of voltage of the driving signal is not 0 (zero) V, offset DC voltage is applied to the piezoelectric element 5, and electrochemical migration may be caused between both electrodes of the piezoelectric element 5.

In this respect, as shown by a waveform c in FIG. 4, the drive circuit 6 switches, every period, a period with a longer low time period tl and a period with a longer high time period th, thus generating a driving signal such that the number of periods with the longer low time period tl and the number of periods with the longer high time period th are the same within the predetermined time period dt. Specifically, the driving signal in the waveform c in FIG. 4 has the same length of a first high time period th1 and a second low time period tl2 and the same length of a first low time period tl1 and a second high time period th2. Therefore, the drive circuit 6 can drive the piezoelectric element 5 such that an average value of voltage applied to the piezoelectric element 5 over the predetermined time period dt is 0 (zero) V, and electrochemical migration caused between both electrodes of the piezoelectric element 5 can be prevented.

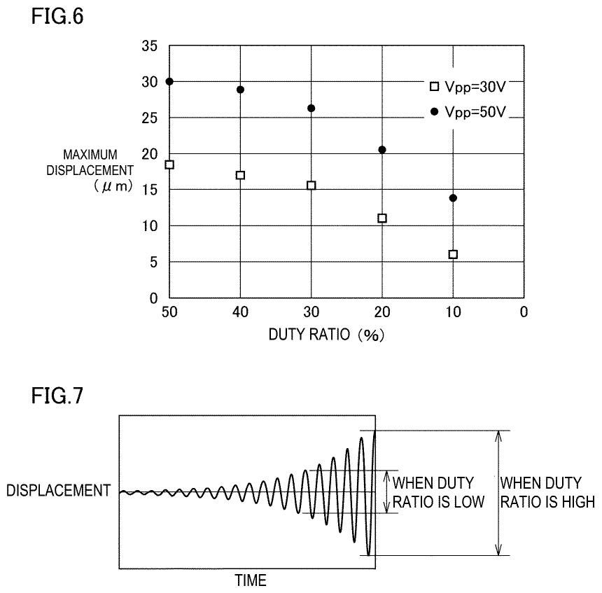

Next, it is described that changing a duty ratio of a driving signal can adjust a vibration level of the outermost layer lens 1. FIG. 5 is a graph for explaining relationship between a displacement of a light transmitting body (e.g., outermost layer lens 1) and a duty ratio of a driving signal. FIG. 6 is a graph for explaining change in a maximum displacement of a light transmitting body (e.g., outermost layer lens 1) in accordance with change in a duty ratio of a driving signal.

In FIG. 5, displacement of the outermost layer lens 1 in a case in which a duty ratio of a driving signal is changed from 10% to 50% are plotted, where a horizontal axis indicates a frequency (kHz), and a vertical axis indicates a displacement (μm) of the outermost layer lens 1. In FIG. 6, maximum displacements of the outermost layer lens 1 in cases in which the voltage Vp-p is 30 V and is 50 V are plotted, where a horizontal axis indicates a duty ratio (%) of a driving signal and a vertical axis indicates a maximum displacement (μm) of the outermost layer lens 1. Note that displacement of the outermost layer lens 1 is measurable by using a laser Doppler displacement meter, for example.

As illustrated in FIGS. 5 and 6, the drive circuit 6 can increase the maximum displacement of the outermost layer lens 1 by changing a duty ratio of a driving signal from 10% to 50% in the case of driving the piezoelectric element 5 in the atomization mode. Therefore, the drive circuit 6 can adjust the maximum displacement (e.g., the vibration level) of the outermost layer lens 1 based on a duty ratio of a driving signal in the atomization mode. Similarly, the drive circuit 6 can be configured to change the maximum displacement of the outermost layer lens 1 based on a duty ratio of a driving signal also in the heating mode, thus precisely adjusting a calorific value of the outermost layer lens 1. Particularly, in the case of driving the piezoelectric element 5 in the heating mode, the drive circuit 6 can prevent overheating and insufficient thaw performance of the outermost layer lens 1 through adjustment of a calorific value based on a duty ratio of a driving signal.

Moreover, it can be described from a perspective of mechanical resonance that changing a duty ratio of a driving signal adjusts a vibration level of the outermost layer lens 1. FIG. 7 is a graph for explaining transient response of vibration when a light transmitting body (outermost layer lens 1) is excited using a driving signal. In FIG. 7, a horizontal axis indicates time, and a vertical axis indicates a displacement of the outermost layer lens 1.

In vibrating the outermost layer lens 1, the outermost layer lens 1 does not reach the maximum displacement at a moment at which voltage is applied to the piezoelectric element 5, but vibration of the outermost layer lens 1 is accelerated through vibration over several periods in accordance with a quality factor of the vibration body 3, and then the outermost layer lens 1 reaches the maximum displacement. Therefore, as illustrated in FIG. 7, in a case in which a duty ratio of a driving signal is low, vibration is switched OFF in a state in which vibration of the outermost layer lens 1 does not sufficiently rise. Thereby, a displacement of the outermost layer lens 1 hits a peak without reaching the maximum displacement and remains a small displacement. On the other hand, in a case in which a duty ratio of a driving signal is high, vibration is switched OFF in a state in which vibration of the outermost layer lens 1 has sufficiently risen. Therefore, a displacement of the outermost layer lens 1 reaches the maximum displacement.

### EXEMPLARY EMBODIMENT 2

Exemplary Embodiment 1 describes the optical device 10 configured to switch between the atomization mode and the heating mode by changing the effective voltage Veff thorough adjustment of a duty ratio of a driving signal, without changing the voltage Vp-p. Whether a frequency of voltage being applied to the piezoelectric element 5 is a resonant frequency can be determined by detection of a value of a current flowing through the piezoelectric element 5. In this respect, Exemplary Embodiment 2 describes an optical device that adjusts a vibration level in accordance with a value of a current flowing through a piezoelectric element.

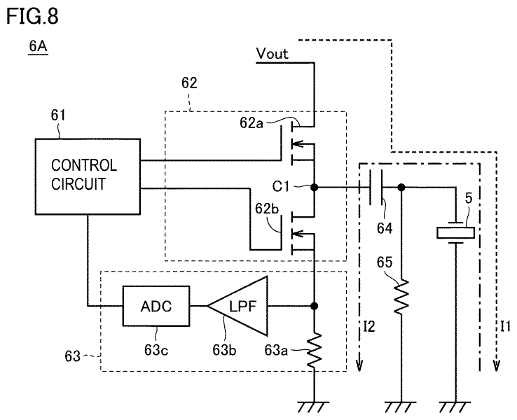

The optical device according to Exemplary Embodiment 2 has the same configurations as the optical device 10 according to Exemplary Embodiment 1, and thus the same configurations are described by using the same reference characters not to repeat the detailed description. FIG. 8 is a circuit diagram for explaining a configuration of a drive circuit 6A according to Exemplary Embodiment 2. The drive circuit 6A includes the control circuit 61, the output circuit 62, a current detection circuit 63, a capacitor 64, and a resistor 65.

The output circuit 62 is connected to a driving power supply circuit. The output circuit 62 includes a series circuit including a first switch 62a to which voltage Vout from the driving power supply circuit is input and a second switch 62b. A connection point Cl between the first switch 62a and the second switch 62b is connected to the piezoelectric element 5 with the capacitor 64 interposed therebetween. Each of the first switch 62a and the second switch 62b is, for example, a metal-oxide-semiconductor field-effect transistor (MOSFET), but is not limited to this configuration.

The current detection circuit 63 can detect at least one of current flowing through the first switch 62a and current flowing through the second switch 62b and output a detection signal indicating a magnitude of the detected current to the control circuit 61. The current detection circuit 63 includes a current voltage conversion element 63a, a low pass filter 63b, and an analog/digital conversion circuit (AD conversion circuit) 63c.

The current voltage conversion element 63a can convert current flowing through the current voltage conversion element 63a into voltage corresponding to a magnitude of the current flowing through the current voltage conversion element 63a. The current voltage conversion element 63a is a resistor (shunt resistor) having a predetermined resistance value. It is noted that the current voltage conversion element 63a is not limited to a shunt resistor but may be a Hall element in an alternative aspect.

The low pass filter 63b is a filter circuit that removes a signal having a frequency component higher than a cutoff frequency. In this embodiment, the low pass filter 63b is connected to a connection point between the current voltage conversion element 63a and the second switch 62b. The low pass filter 63b is configured to smooth a voltage input from the current voltage conversion element 63a and outputs the smoothed voltage to an AD conversion circuit 63c.

The AD conversion circuit 63c is a circuit that is configured to convert the voltage (e.g., an analog signal) smoothed by the low pass filter 63b into a digital signal that is configured to be input to the control circuit 61. The AD conversion circuit 63c outputs the digital signal to the control circuit 61 as a detection signal. The current detection circuit 63 does not necessarily include the AD conversion circuit 63c, and the low pass filter 63b may output smoothed voltage to the control circuit 61 as a detection signal.

The current detection circuit 63 is configured to output, to the control circuit 61, a detection signal that is a digital signal generated based on a magnitude of current flowing through the second switch 62b, but the current detection circuit 63 is not limited to this configuration. For example, the current detection circuit 63 may include only the current voltage conversion element 63a and the low pass filter 63b and output, to the control circuit 61, a detection signal that is not a digital signal but an analog signal.

In a first state described later, the capacitor 64 can charge based on the voltage Vout applied by the driving power supply circuit. In a second state described later, the capacitor 64 can discharge to a ground potential via the second switch 62b. Therefore, by the control circuit 61 controlling switching processing of the first switch 62a and the second switch 62b, the drive circuit 6A can flow current I1 and current I2 to the piezoelectric element 5.

The resistor 65 is connected between the ground potential and a connection point between the piezoelectric element 5 and the capacitor 64. The piezoelectric element 5 has a one-end side connected to the ground potential with the resistor 65 interposed therebetween, and thereby, once the switching processing by the control circuit 61 ends, the one-end side and the other-end side of the piezoelectric element 5 have an equipotential.

The control circuit 61 of the drive circuit 6A executes the switching processing where the first switch 62a and the second switch 62b are complementarily switched at a switching frequency. That is, the control circuit 61 controls the first switch 62a and the second switch 62b such that the second switch 62b is in an OFF state when the first switch 62a is ON (e.g., a first state). Moreover, the control circuit 61 controls the first switch 62a and the second switch 62b such that the second switch 62b is in an ON state when the first switch 62a is OFF (e.g., a second state). The control circuit 61 complementarily switches the first switch 62a and the second switch 62b, so that the control circuit 61 applies a drive voltage Vdrv as a driving signal to the piezoelectric element 5 based on the voltage Vout from the driving power supply circuit. The drive voltage Vdrv has a frequency corresponding to the switching frequency.

In the first state, the current I1 flows into the drive circuit 6A via the first switch 62a. In FIG. 8, the current I1 is indicated by a broken-line arrow. As illustrated in FIG. 8, the current I1 flows from the driving power supply circuit to the piezoelectric element 5 via the first switch 62a. Therefore, the piezoelectric element 5 is applied with voltage having a higher potential at the drive circuit 6A side.

In the drive circuit 6A, when voltage is applied to the piezoelectric element 5 in the first state, the capacitor 64 intervening between the output circuit 62 and the piezoelectric element 5 accumulates positive charge at the output circuit 62 side and negative charge at the ground potential side. When the control circuit 61 changes the output circuit 62 from the first state to the second state, the capacitor 64 and the piezoelectric element 5 discharge. In the second state, the discharge flows as the current I2 into the drive circuit 6A via the second switch 62b. In FIG. 8, the current I2 is indicated by a one-dot chain-line arrow. As illustrated in FIG. 8, the current I2 flows from the piezoelectric element 5 to the ground potential via the second switch 62b. Moreover, the capacitor 64 accumulates negative charge at the output circuit 62 side and positive charge at the piezoelectric element 5 side. Therefore, the piezoelectric element 5 is applied with voltage having a lower potential at the drive circuit 6A side.

As described above, the drive circuit 6A can output a driving signal with polarity inverted at a predetermined frequency to the piezoelectric element 5 by switching the first switch 62a and the second switch 62b. Therefore, the drive circuit 6A can adjust a frequency of a driving signal by controlling a switching frequency for switching the first switch 62a and the second switch 62b.

Moreover, the drive circuit 6A can determine a resonant frequency of the vibration body 3 by changing a switching frequency within a predetermined frequency range. Specifically, the drive circuit 6A changes the switching frequency at a predetermined increase rate (or decrease rate) within a predetermined frequency range, and determines, as the resonant frequency, a switching frequency with a largest current value detected by the current detection circuit 63. Therefore, the drive circuit 6A can determine a vibration level based on a current value detected by the current detection circuit 63 and can change a duty ratio of a driving signal in such a manner as to correspond to the determined vibration level. That is, the drive circuit 6A can change a duty ratio of a driving signal corresponding to a current value detected by the current detection circuit 63, thus being configured to adjust performance difference attributed to individual difference of devices and temperature characteristics.

### Exemplary Embodiment 3

Exemplary Embodiment 1 describes the optical device 10 configured to change the effective voltage Veff by adjusting a duty ratio of a driving signal. However, a method for changing the effective voltage Veff is not limited to this but may be a method of decimating a part of a pulse signal from a driving signal that is a pulse signal repeating a high time period and a low time period. Exemplary Embodiment 3 describes an optical device configured to reduce an effective voltage by decimating a pulse signal for every certain period from a driving signal. The optical device according to Exemplary Embodiment 3 has the same configurations as the optical device 10 according to Exemplary Embodiment 1, and thus the same configurations are described by using the same reference characters not to repeat the detailed description.

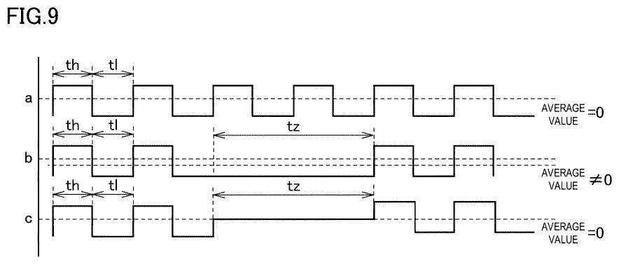

FIG. 9 is a chart for illustrating a driving signal that drives the piezoelectric element 5 by the drive circuit 6 according to Exemplary Embodiment 3. As indicated by a waveform a in FIG. 9, the drive circuit 6 uses, as a driving signal to be output to the piezoelectric element 5, a square wave in which the high time period th with voltage at a positive value and the low time period tl with voltage at a negative value form one period.

In order to change the effective voltage Veff, the drive circuit 6 fixes voltage in a decimation time period tz to a low level (−Vpp) as shown by a waveform b in FIG. 9. In the waveform b in FIG. 9, the decimation time period tz includes two periods, and a pulse signal is decimated for every two periods. Note that, in the waveform b in FIG. 9, voltage in the decimation time period tz is described to be fixed to the low level (−Vpp), but the voltage in the decimation time period tz may be fixed to a high level (+Vpp).

In the case in which the voltage in the decimation time period tz is fixed to the low level (−Vpp) or the high level (+Vpp), as shown by the waveform b in FIG. 9, an average value of voltage over a plurality of periods does not become 0 (zero) V but takes a negative value (in the case of fixing to the high level (+Vpp), the average value of voltage takes a positive value). When the average value of voltage of the driving signal is not 0 (zero) V, offset DC voltage is applied to the piezoelectric element 5, and electrochemical migration may be caused between both electrodes of the piezoelectric element 5.

In this respect, as shown by a waveform c in FIG. 9, the drive circuit 6 does not fix voltage in the decimation time period tz to the low level (−Vpp) or the high level (+Vpp), but fix it to 0 (zero) V (GND). Specifically, in the case in which the output circuit 62 is a half-bridge circuit including the first switch 62a and the second switch 62b illustrated in FIG. 8, the voltage in the decimation time period tz can be fixed to 0 (zero) V (GND) by the first switch 62a and the second switch 62b being in the OFF state.

Although the optical device 10 according to Exemplary Embodiment 3 is described to change the effective voltage Veff by providing the decimation time period tz to a driving signal, this may be combined with the method described in Exemplary Embodiment 1 in which the effective voltage Veff is changed by adjustment of a duty ratio of a driving signal.

Generalized relationship between a driving signal in the atomization mode and a driving signal in the heating mode by using the decimation time period tz and a duty ratio of a driving signal is relationship as represented by Formula 2.

$$\begin{matrix}[ Math . 2 ] & \\ \int \{ ta\_ 1 / ( th\_ 1 + tl\_ 1 + t z ) \} d t > \int \{ ta\_ 2 / ( th\_ 2 + tl\_ 2 + tz ) \} dt & ( Formula 2 )\end{matrix}$$

Here, assume that the atomization mode includes the high time period th_1, the low time period tl_1, and the active time period ta_1, and the heating mode includes the high time period th_2, the low time period tl_2, and the active time period ta_2. Assume that decimation time periods for the atomization mode and for the heating mode are both the decimation time period tz. Further, the driving signal represented by Formula 2 preferably adjusts the high time period th_1 and the low time period tl_1 in the atomization mode and the high time period th_2 and the low time period tl_2 in the heating mode such that an average value of voltage over the predetermined time period dt is 0 (zero) V.

### Exemplary Embodiment 4

Exemplary Embodiment 1 describes the optical device 10 configured to change the effective voltage Veff by adjusting a duty ratio of a driving signal. However, the method for changing the effective voltage Veff is not so limited, and a method of changing a load of a drive circuit may be employed. Exemplary Embodiment 4 describes an optical device configured to reduce an effective voltage by inserting a filter circuit between a drive circuit and a piezoelectric element to change a load of the drive circuit. The optical device according to Exemplary Embodiment 4 has the same configurations as the optical device 10 according to Exemplary Embodiment 1, and thus the same configurations are described by using the same reference characters not to repeat the detailed description.

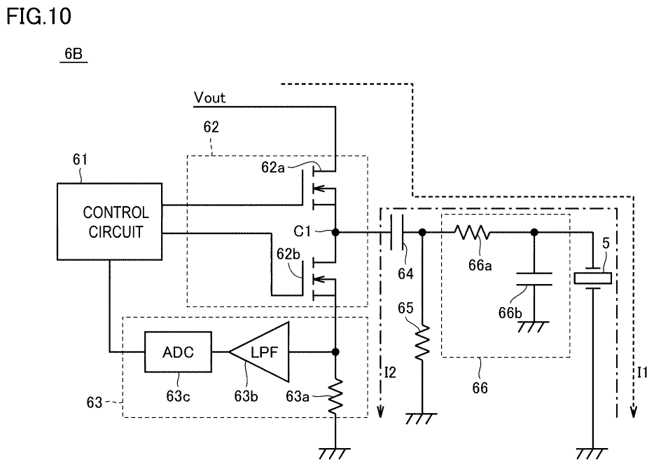

FIG. 10 is a circuit diagram for explaining a configuration of a drive circuit 6B according to Exemplary Embodiment 4. The drive circuit 6B includes the control circuit 61, the output circuit 62, the current detection circuit 63, the capacitor 64, the resistor 65, and a filter circuit 66. The filter circuit 66 is not necessarily included in the drive circuit, but the filter circuit 66 may be inserted between the drive circuit 6 and the piezoelectric element 5 illustrated in FIG. 2 or may be inserted between the drive circuit 6A and the piezoelectric element 5 illustrated in FIG. 8. Note that, with regard to the drive circuit 6B illustrated in FIG. 10, the same configurations as those of the drive circuit 6A illustrated in FIG. 8 are denoted by the same reference characters not to repeat the detailed description.

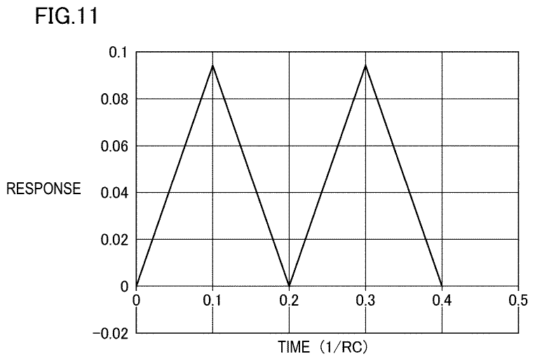

The filter circuit 66 is a low pass filter (LPF) including a resistor 66a and a capacitor 66b. The filter circuit 66 can output, in a form of a signal approximate to a triangle wave, a square-wave driving signal obtained by switching of the first switch 62a and the second switch 62b at a switching frequency significantly higher than (for example, about one tenth of) a time constant (RC). FIG. 11 is a graph for explaining characteristics of the filter circuit 66 included in the drive circuit 6B according to Exemplary Embodiment 4. In FIG. 11, a horizontal axis indicates time, and a vertical axis indicates response.

The filter circuit 66 outputs, in a form of a signal approximate to a triangle wave, as illustrated in FIG. 11, an input square-wave driving signal, thus being configured to reduce an effective voltage of the driving signal. In a case in which voltage of difference (e.g., peak-to-peak value) between a maximum value and a minimum value of a signal approximate to a triangle wave is the same as voltage of difference (e.g., peak-to-peak value) between a maximum value (+Vpp) and a minimum value (−Vpp) of a driving signal, an effective voltage of the signal approximate to a triangle wave is about half an effective voltage of the driving signal. Note that in the case of the signal approximate to a triangle wave as illustrated in FIG. 11, the drive circuit 6B causes the direct-current voltage Vout_1 for generating a driving signal (e.g., an alternating current signal) that drives the piezoelectric element 5 in the atomization mode to vibrate the outermost layer lens 1 to be the same as the direct-current voltage Vout_2 for generating a driving signal that drives the piezoelectric element 5 in the heating mode (Vout_1=Vout_2).

The drive circuit 6B illustrated in FIG. 10 includes one stage of the filter circuit 66 inserted between the output circuit 62 and the piezoelectric element 5. However, the configuration is not so limited, and the drive circuit 6B may have multiple stages of the filter circuit 66 inserted in alternative aspects. The drive circuit 6B can include multiple stages of the filter circuit 66 inserted between the output circuit 62 and the piezoelectric element 5 to output a sine-wave driving signal.

As illustrated in FIG. 3, a frequency of a driving signal that drives the piezoelectric element 5 in the atomization mode is lower than a frequency of a driving signal that drives the piezoelectric element 5 in the heating mode. Therefore, the drive circuit 6B causes the time constant (RC) to be less than a half period of a driving signal that drives the piezoelectric element 5 in the atomization mode and more than a half period of a driving signal that drives the piezoelectric element 5 in the heating mode. In this way, the effective voltage Veff_1 in the atomization mode can be higher than the effective voltage Veff_2 in the heating mode (i.e., Veff_1>Veff_2).

Moreover, the resistor 66a and the capacitor 66b included in the filter circuit 66 may have variable resistance and variable capacitance, respectively, so that the drive circuit 6B may change a resistance value of the resistor 66a and a capacitance value of the capacitor 66b in accordance with a current value detected by the current detection circuit 63. The drive circuit 6B is configured to change the resistance value of the resistor 66a and the capacitance value of the capacitor 66b in accordance with the current value detected by the current detection circuit 63, thus being capable of adjusting performance difference attributed to individual difference of devices and temperature characteristics.

It is noted that the configuration of the drive circuit 6B according to Exemplary Embodiment 4 can be combined with an optical device according to another embodiment described herein as would be appreciated to one skilled in the art.

### Modifications of the Exemplary Embodiments

In the optical device 10 according to the embodiments, the cross-sectional shape of the supporting part 33 is described to be an S-shape. However, it is noted that the cross-sectional shape of the supporting part 33 is not limited to an S-shape as long as a shape thereof does not cause stress concentration on the vibration body. For example, the cross-sectional shape of the supporting part 33 may be a shape where a plurality of S-shapes is coupled together. Alternatively, since the cross-sectional shape of the supporting part 33 may be any shape having a smaller portion with less stress concentration thereon in the supporting part 33, the cross-sectional shape may be a curved shape having half of an S-shape.

The imaging unit 100 according to the above-described embodiments may include a camera, a LiDAR, a Radar, and the like. In addition, a plurality of imaging units 100 may be arranged side by side.

It is noted that the imaging unit 100 according to the above-described embodiments is not limited to an imaging unit provided in a vehicle but can be similarly applied as any imaging unit that includes an optical device and an imaging element, which is disposed such that a light transmitting body is disposed in a viewing direction thereof, and that needs to remove foreign matter on a light transmitting body.

### Exemplary Aspects

(1) An optical device according to an exemplary aspect of the present disclosure includes a light transmitting body configured to transmit light; a housing configured to hold the light transmitting body; a vibration body configured to contact the light transmitting body held by the housing; a piezoelectric element configured to vibrate the vibration body; and a drive circuit configured to drive the piezoelectric element. In this aspect, the vibration body is a cylindrical body and includes a first end and a second end at an opposite side from the first end. The first end contacts the light transmitting body and the piezoelectric element is disposed on the second end. The drive circuit configures a voltage Vp-p_1 of an alternating current signal that drives the piezoelectric element in a first vibration mode to vibrate the light transmitting body to be same as a voltage Vp-p_2 of an alternating current signal that drives the piezoelectric element in a second vibration mode among the plurality of vibration modes, and drives the piezoelectric element such that an effective voltage Veff_1 applied to the piezoelectric element within a predetermined time period in the first vibration mode is different from an effective voltage Veff_2 applied to the piezoelectric element within the predetermined time period in the second vibration mode.

(2) In an exemplary aspect of the optical device according to aspect (1), the drive circuit is configured to drive the piezoelectric element such that the effective voltage Veff_1 applied to the piezoelectric element within the predetermined time period in the first vibration mode is higher than the effective voltage Veff_2 applied to the piezoelectric element within the predetermined time period in the second vibration mode.

(3) In an exemplary aspect of the optical device according to aspects (1) or (2), the drive circuit is configured to drive the piezoelectric element such that a vibration amplitude Av_1 of the light transmitting body in the first vibration mode is larger than a vibration amplitude Av_2 of the light transmitting body in the second vibration mode and power Pv_1 input in the first vibration mode is less than power Pv_2 input in the second vibration mode.

(4) In an exemplary aspect of the optical device according to any one of aspects (1) to (3), the drive circuit is configured to drive the piezoelectric element such that a first integral value is larger than a second integral value, the first integral value being an integral of a duty ratio of an alternating current signal that drives the piezoelectric element in the first vibration mode over the predetermined time period, the second integral value being an integral of a duty ratio of an alternating current signal that drives the piezoelectric element in the second vibration mode over the predetermined time period.

(5) In an exemplary aspect of the optical device according to aspect (4), the drive circuit is configured to drive the piezoelectric element such that an average value of voltage applied to the piezoelectric element over the predetermined time period is 0 (zero) V.

(6) In an exemplary aspect of the optical device according to aspects (4) or (5), the drive circuit is configured to drive the piezoelectric element such that an alternating current signal that drives the piezoelectric element includes a time period during which a voltage value is 0 (zero) and the first integral value is larger than the second integral value.

(7) In an exemplary aspect of the optical device according to any one of aspects (1) to (6), the drive circuit includes a current detection circuit configured to detect a value of a current flowing through the piezoelectric element, and a control circuit configured to change, in accordance with the current value detected by the current detection circuit, a duty ratio of an alternating current signal that drives the piezoelectric element to execute control such that the effective voltage Veff_1 is larger than the effective voltage Veff_2.

(8) In an exemplary aspect of the optical device according to any one of aspects (1) to (7), the drive circuit is configured to output an alternating current signal to the piezoelectric element via a filter circuit, and a time constant of the filter circuit is less than a half period of an alternating current signal that drives the piezoelectric element in the first vibration mode and more than a half period of an alternating current signal that drives the piezoelectric element in the second vibration mode.

(9) In an exemplary aspect of the optical device according to any one of aspects (1) to (8), the first vibration mode is an atomization mode in which the light transmitting body is vibrated to atomize foreign matter adhering to the light transmitting body, and the second vibration mode is a heating mode in which the light transmitting body is vibrated to heat the light transmitting body.

(10) In an exemplary aspect, the optical device according to aspect (9) further includes: a switch part configured to switch a mode for vibrating the light transmitting body among the plurality of vibration modes, and the switch part switches between the atomization mode and the heating mode based on an image acquired by an imaging element.

(11) In another exemplary aspect, an optical device according to the present disclosure includes a light transmitting body configured to transmit light; a housing configured to hold the light transmitting body; a vibration body configured to contact the light transmitting body held by the housing; a piezoelectric element configured to vibrate the vibration body; and a drive circuit configured to drive the piezoelectric element. The vibration body is a cylindrical body and includes a first end and a second end at an opposite side from the first end. The first end contacts the light transmitting body, and the piezoelectric element is provided on the second end. The drive circuit includes a driving power supply circuit, and an output circuit configured to convert direct-current voltage output from the driving power supply circuit into an alternating current signal, which causes a direct-current voltage Vout_1 for generating an alternating current signal that drives the piezoelectric element in a first vibration mode to vibrate the light transmitting body to be same as a direct-current voltage Vout_2 for generating an alternating current signal that drives the piezoelectric element in a second vibration mode among the plurality of vibration modes, and drives the piezoelectric element such that an effective voltage Veff_1 applied to the piezoelectric element within a predetermined time period in the first vibration mode is different from an effective voltage Veff_2 applied to the piezoelectric element within the predetermined time period in the second vibration mode.

(12) In another exemplary aspect, an imaging unit according to the present disclosure includes: the optical device according to any one of aspects (1) to (11); and an imaging element disposed such that the light transmitting body is disposed in a viewing direction thereof.

It is noted that the exemplary embodiments disclosed herein are to be considered in all respects as illustrative and not restrictive.

### REFERENCE SIGNS LIST

1 outermost layer lens
2 housing
2a plate spring
2b retainer
3 vibration body
4 inner layer lens
5 piezoelectric element
6, 6A, 6B drive circuit
7 driving power supply circuit
10 optical device
20 imaging element
61 control circuit
62 output circuit
63 current detection circuit
64, 66b capacitor
65, 66a resistor
66 filter circuit
100 imaging unit

1. An optical device comprising:
a light transmitting body configured to transmit light;
a housing configured to hold the light transmitting body;
a vibration body configured to contact the light transmitting body held by the housing;
a piezoelectric element configured to vibrate the vibration body; and
a drive circuit configured to drive the piezoelectric element,
wherein the vibration body includes a first end contacting the light transmitting body, and a second end at an opposite side from the first end and on which the piezoelectric element is disposed, and
wherein the drive circuit is configured to:
configure a voltage Vp-p_1 of an alternating current signal that drives the piezoelectric element in a first vibration mode to vibrate the light transmitting body to be the same as a voltage Vp-p_2 of an alternating current signal that drives the piezoelectric element in a second vibration mode, and
drive the piezoelectric element such that an effective voltage Veff_1 applied to the piezoelectric element within a predetermined time period in the first vibration mode is different from an effective voltage Veff_2 applied to the piezoelectric element within the predetermined time period in the second vibration mode.

2. The optical device according to claim 1, wherein the piezoelectric element is directly disposed on the vibration body.

3. The optical device according to claim 1, wherein the vibration body is a cylindrical body having the first end and the second end that oppose each other.

4. The optical device according to claim 1, wherein the drive circuit is configured to drive the piezoelectric element such that the effective voltage Veff_1 applied to the piezoelectric element within the predetermined time period in the first vibration mode is higher than the effective voltage Veff_2 applied to the piezoelectric element within the predetermined time period in the second vibration mode.

5. The optical device according to claim 1, wherein the drive circuit is configured to drive the piezoelectric element such that a vibration amplitude Av_1 of the light transmitting body in the first vibration mode is larger than a vibration amplitude Av_2 of the light transmitting body in the second vibration mode.

6. The optical device according to claim 5, wherein the drive circuit is configured to drive the piezoelectric element such that a power Pv_1 input in the first vibration mode is less than a power Pv_2 input in the second vibration mode.

7. The optical device according to claim 1, wherein the drive circuit is configured to drive the piezoelectric element such that a first integral value is larger than a second integral value, the first integral value being an integral of a duty ratio of an alternating current signal that drives the piezoelectric element in the first vibration mode over the predetermined time period, and the second integral value being an integral of a duty ratio of an alternating current signal that drives the piezoelectric element in the second vibration mode over the predetermined time period.

8. The optical device according to claim 7, wherein the drive circuit is configured to drive the piezoelectric element such that an average value of the voltage applied to the piezoelectric element over the predetermined time period is zero V.

9. The optical device according to claim 7, wherein the drive circuit is configured to drive the piezoelectric element such that an alternating current signal that drives the piezoelectric element includes a time period during which a voltage value is zero volts and the first integral value is larger than the second integral value.

10. The optical device according to claim 1, wherein the drive circuit includes:
a current detection circuit configured to detect a value of a current flowing through the piezoelectric element, and
a control circuit configured to change, based on the detected current value, a duty ratio of an alternating current signal that drives the piezoelectric element such that the effective voltage Veff_1 is larger than the effective voltage Veff_2.

11. The optical device according to claim 1, wherein the drive circuit is configured to output an alternating current signal to the piezoelectric element via a filter circuit.

12. The optical device according to claim 11, wherein a time constant of the filter circuit is less than a half period of an alternating current signal that drives the piezoelectric element in the first vibration mode and more than a half period of an alternating current signal that drives the piezoelectric element in the second vibration mode.

13. The optical device according to claim 1, wherein:
the first vibration mode is an atomization mode in which the light transmitting body is vibrated to atomize foreign matter adhering to the light transmitting body, and
the second vibration mode is a heating mode in which the light transmitting body is vibrated to heat the light transmitting body.

14. The optical device according to claim 13, further comprising:
a switch configured to switch a mode for vibrating the light transmitting body from the first vibration mode to the second vibration mode,
wherein the switch is configured to switch between the atomization mode and the heating mode based on an image acquired by an imaging element.

15. An optical device comprising:
a light transmitting body;
a housing configured to hold the light transmitting body;
a vibration body configured to contact the light transmitting body;
a piezoelectric element configured to vibrate the vibration body; and
a drive circuit configured to drive the piezoelectric element,
wherein the vibration body includes a first end that contacts the light transmitting body and a second end on which the piezoelectric element is disposed,
wherein the drive circuit includes a driving power supply circuit, and an output circuit configured to convert a direct-current voltage output from the driving power supply circuit into an alternating current signal,
wherein the drive circuit is configured to cause a direct-current voltage Vout_1 for generating an alternating current signal that drives the piezoelectric element in a first vibration mode to vibrate the light transmitting body to be a same voltage as a direct-current voltage Vout_2 for generating an alternating current signal that drives the piezoelectric element in a second vibration mode, and
wherein the drive circuit is configured to drive the piezoelectric element such that an effective voltage Veff_1 applied to the piezoelectric element within a predetermined time period in the first vibration mode is different from an effective voltage Veff_2 applied to the piezoelectric element within the predetermined time period in the second vibration mode.

16. The optical device according to claim 15, wherein the piezoelectric element is directly disposed on the vibration body.

17. The optical device according to claim 15, wherein the vibration body is a cylindrical body having the first end and the second end that oppose each other.

18. The optical device according to claim 15, wherein:
the first vibration mode is an atomization mode in which the light transmitting body is vibrated to atomize foreign matter adhering to the light transmitting body, and
the second vibration mode is a heating mode in which the light transmitting body is vibrated to heat the light transmitting body.

19. An imaging unit comprising:
the optical device according to claim 1; and
an imaging element disposed such that the light transmitting body is disposed in a viewing direction thereof.

20. An imaging unit comprising:
the optical device according to claim 15; and
an imaging element disposed such that the light transmitting body is disposed in a viewing direction thereof.
